(19) United States
(12) Patent Application Publication
(10) Pub. No.: US 2004/0002981 A1
(43) Pub. Date: Jan. 1, 2004

(54) System and method for handling a high-cardinality attribute in decision trees

(75) Inventors: Jeffrey R. Bernhardt, Woodinville, WA (US); Pyungchul Kim, Snoqualmie, WA (US); C. James MacLennan, Redmond, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation

(21) Appl. No.: 10/185,048

(22) Filed: Jun. 28, 2002

(51) Int. Cl. G06F 17/00; G06F 7/00

(52) U.S. Cl. 707/100

(57) ABSTRACT

High-cardinality attributes are used as input attributes and as output attributes in decision tree creation. When determining which attribute test to use at a node, a distribution of states for the high-cardinality attribute in the testing data at the node is created. A certain number of the most common states for the high-cardinality attribute are selected. The most common states are used as the states for the high-cardinality attribute in determining which attribute test to use. The remaining states are combined into one state and used as a single state for the high-cardinality attribute in determining which attribute test to use. The high-cardinality attribute may be either an input attribute or an output attribute to the decision tree.

### FIELD OF THE INVENTION

The present invention relates to systems and methods for using an attribute with high-cardinality as either an input attribute or an output attribute in training a decision tree.

### BACKGROUND OF THE INVENTION

Data mining is the exploration and analysis of large quantities of data, in order to discover correlations, patterns, and trends in the data. Data mining may also be used to create models that can be used to predict future data or classify existing data.

For example, a business may amass a large collection of information about its customers. This information may include purchasing information and any other information available to the business about the customer. The predictions of a model associated with customer data may be used, for example, to control customer attrition, to perform credit-risk management, to detect fraud, or to make decisions on marketing.

To create and test a data mining model such as a decision tree, available data may be divided into two parts. One part, the training data set, may be used to create models. The rest of the data, the testing data set, may be used to test the model, and thereby determine the performance of the model in making predictions. Data within data sets is grouped into cases. For example, with customer data, each case corresponds to a different customer. All data in the case describes or is otherwise associated with that customer.

One type of predictive model is the decision tree. Decision trees are used to classify cases with specified input attributes in terms of an output attribute. Once a decision tree is created, it can be used predict the output attribute of a given case based on the input attributes of that case.

Decisions trees are composed of nodes and leaves. One node is the root node. Each node has an associated attribute test that splits cases that reach that node to one of the children of the node based on an input attribute. The tree can be used to predict a new case by starting at the root node and tracing a path down the tree to a leaf, using the input attributes of the new case in the attribute tests in each node. The path taken by a case corresponds to a conjunction of attribute tests in the nodes. The leaf contains the decision tree's prediction for the output attribute(s) based on the input attributes.

An exemplary decision tree is shown in FIG. 1. In this decision tree, or example, if a decision tree is being used to predict a customer's credit risk, input attributes may include debt level, employment, and age, and the output attribute is a prediction of what the credit risk for the customer is. As shown in FIG. 1, decision tree 200 consists of root node 210, node 212, and leaves 220, 222 and 224. The input attributes are debt level and type of employment, and the output attribute is credit risk. Each node has associated with it a split constraint based on one of the input attributes. For example, the split constraint of root node 210 is whether debt level is high or low. Cases where the value of the debt input attribute is “high” will be transferred to leaf 224 and all other cases will be transferred to node 212. Because leaf 224 is a leaf, it gives the prediction the decision tree model will give if a case reaches leaf 224. For decision tree 200, all cases with a “high” value for the debt input attribute will have credit risk output attribute assigned to “bad” with a 100% probability. The decision tree 200 in FIG. 1 predicts only one output attribute, however more than one output attribute may be predicted with a single decision tree.

While the decision tree may be displayed and stored in a decision tree data structure, it may also be stored in other ways, for example, as a set of rules, one for each leaf node, containing a conjunction of the attribute tests.

Input attributes and output attributes do not have to be binary attributes, with two possible states. Attributes can have many states. In some decision tree creation contexts, attribute tests must be binary. Binary attribute tests divide data into two groups—one group of data that meets a specific test, and one group of data that does not. Therefore for an attribute with many states (e.g. a color variable with possible states {red, green, blue, violet}) a binary attribute test must be based on the selection of one of the states. Such an attribute test may therefore ask whether, for input attribute color, is the value of that attribute the state “red” and data at the node will be split into data for which the value of the attribute is “red” in one child, and data for which the value of the attribute is not “red” in another child.

In order to create the tree, the nodes, attribute tests, and leaf values must be decided upon. Generally, creating a tree is an inductive process. Given an existing tree, all testing data is processed by the tree, starting with the root node, divided according to the attribute test to nodes below, until a leaf is reached. The data at each leaf is then examined to determine whether and how a split should be performed, creating a node with an attribute test leading to two leaf nodes in place of the leaf node. This is done until the data at each node is sufficiently homogenous. In order to begin the induction the root node is treated as a leaf.

To determine whether a split should be performed, a score gain is calculated for each possible attribute test that might be assigned to the node. This score gain corresponds to the usefulness of using that attribute test to split the data at that node. There are many ways to determine which attribute test to use using the score gain. For example, the decision tree may be built by using the attribute test that reduces the amount of entropy at the node. Entropy is a measure of the homogeneity of the data. The data at the node must be split into two groups of data which each are heterogeneous from each other based on the output attribute for which the tree is being generated.

In order to determine what the usefulness is of splitting the data at the node with a specific attribute test, the resultant split of the data at the node for each output attribute must be computed. This correlation data is used to determine a score which is used to select an attribute test for the node. Where the input attribute being considered is gender, for example, and the output attribute is car color, the data from the following Table 1 must be computed for the testing data that reaches the node being split:

TABLE 1

| | gender = MALE | gender ≠ MALE |
|---|---|---|
| car color = RED | 359 | 503 |
| car color ≠ RED | 4903 | 3210 |

As described above, data in a correlation count table such as that shown in Table 1 must be calculated for each combination of a possible input attribute test and output attribute description. This means that not only must the gender input attribute be examined to see how it splits the data at the node into red cars and non-red cars, but it must also examine how the gender input attribute splits the data at the node into blue cars and non-blue ones, green cars and non-green ones, etc., for every possible state of the “car color” variable.

Calculating this data is computationally expensive. Where an attribute has two states, for example: gender={MALE, FEMALE}, there is only one possible binary attribute test or output description which must be considered, since if the gender variable is not assigned one state, then it must be the other. But where an attribute has more than two states, for example: car color={RED, BLUE, GREEN, WHITE, BLACK, . . . }, there are as many binary attribute tests (if the attribute is an input attribute) or binary output attribute descriptions (if the attribute is an output attribute) as there are states. When an input attribute has M possible states, where M>2, then M correlation count tables must be produced for each output attribute description. One correlation must be done for each color, separating the data with that color for the car color from that without it. Similarly, where an output attribute has M>2 states, then M correlation count tables must be produced for each input attribute test.

Because of the multiplicity of correlation count table calculations required, attributes with a high number of possible states, known as “high-cardinality attributes” are problematic. Because of the memory space and processing time that would be required to calculate correlation count tables, these high-cardinality attributes are generally ignored as input attributes and not allowed as output attributes. However, high-cardinality attributes in data may have useful information for use as input attributes. For example, zip code or state of residence may contain very useful information, but are of high-cardinality. Similarly, it may be useful to include high-cardinality attributes as output attributes in decision trees.

Thus, there is a need for a technique to allow the use of high-cardinality attributes as input attributes and output attributes in decision trees.

### SUMMARY OF THE INVENTION

In view of the foregoing, the present invention provides systems and methods for using a high-cardinality attribute as an input attribute to a decision tree. First, the testing data at the node is analyzed to obtain a distribution of states of the attribute in the testing data. A certain number of the most common states for the attribute in the testing data are selected, and only those most common states of the input attribute are considered for the attribute test for that node. The technique may be performed iteratively at subsequent nodes. Additionally, the present invention provides systems and methods for using a high-cardinality attribute as an output attribute to a decision tree. First, the testing data at the node is analyzed to obtain a distribution of states of the attribute in the testing data. A certain number of the most common states for the attribute in the testing data are selected, and only those most common states of the input attribute are considered for the attribute test for that node. The technique may be performed iteratively at subsequent nodes.

### BRIEF DESCRIPTION OF THE DRAWINGS

The system and methods for using high-cardinality attributes in decision trees in accordance with the present invention are further described with reference to the accompanying drawings in which:

FIG. 1 is a block diagram depicting an exemplary decision tree.

FIG. 2 is a block diagram of an exemplary computing environment in which aspects of the invention may be implemented.

FIG. 3 is a block diagram of the use of a high-cardinality attribute as an input attribute according to one embodiment of the present invention.

FIG. 4 is a block diagram of the use of a high-cardinality attribute as an output attribute according to one embodiment of the present invention.

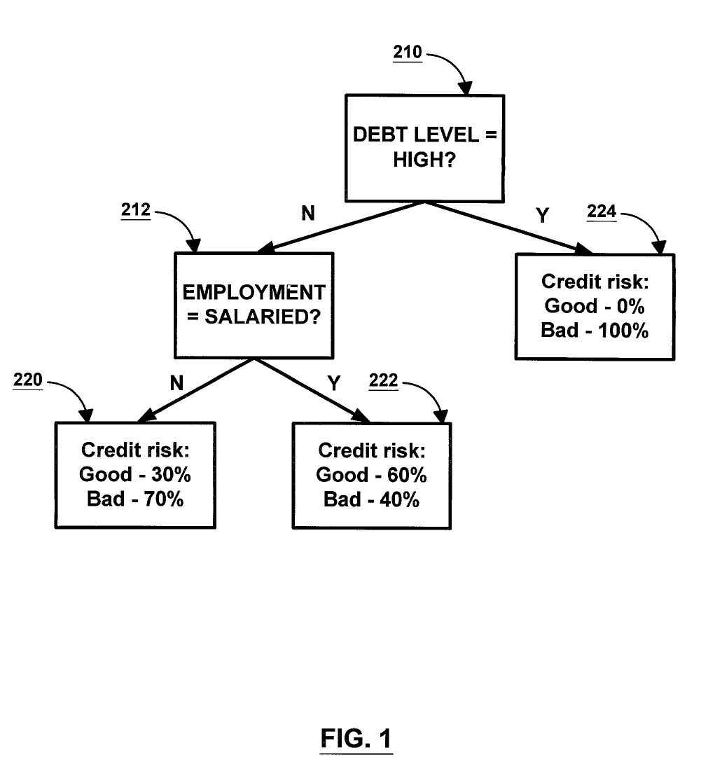

### DETAILED DESCRIPTION OF THE INVENTION

Overview

As described in the background, conventionally, high-cardinality attributes are not used either as input attributes or as output attributes in decision tree creation. Ignoring the high-cardinality attribute causes a decrease in the usefulness of the decision tree, since content from the training data is being ignored. Using the high-cardinality attribute requires a severe cost in terms of time and processing power. In order to allow the use of high-cardinality data, the testing data at the node is sampled in order to determine what the most popular states of the high-cardinality data at the node are. Once the popularity-preferred states are identified, these states are used, and the other states ignored, in making calculations to determine which attribute test to use at the node.

Exemplary Computing Environment

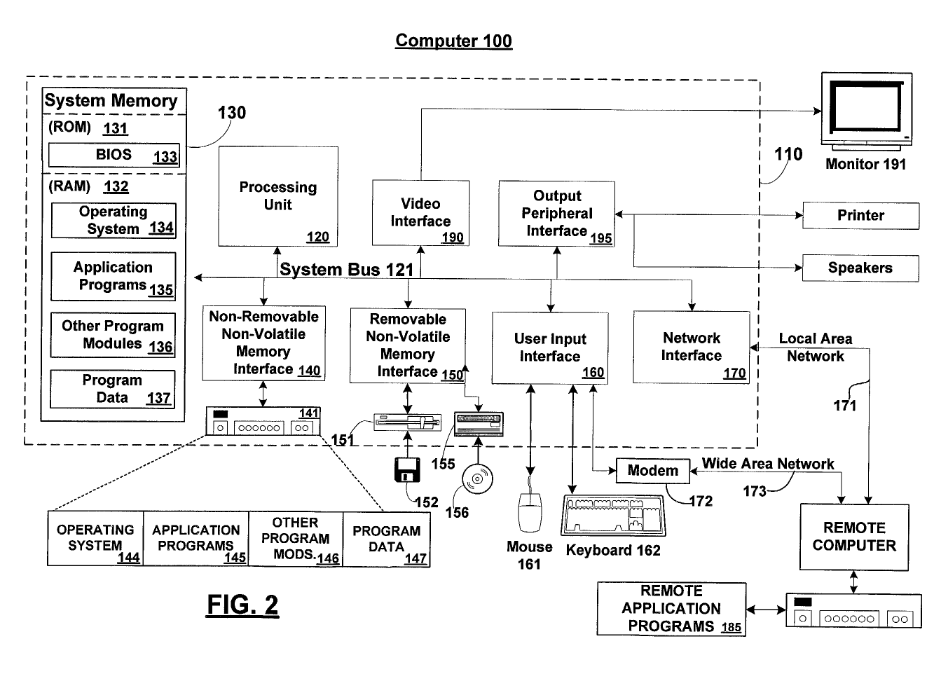

FIG. 2 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

One of ordinary skill in the art can appreciate that a computer or other client or server device can be deployed as part of a computer network, or in a distributed computing environment. In this regard, the present invention pertains to any computer system having any number of memory or storage units, and any number of applications and processes occurring across any number of storage units or volumes, which may be used in connection with the present invention. The present invention may apply to an environment with server computers and client computers deployed in a network environment or distributed computing environment, having remote or local storage. The present invention may also be applied to standalone computing devices, having programming language functionality, interpretation and execution capabilities for generating, receiving and transmitting information in connection with remote or local services.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices. Distributed computing facilitates sharing of computer resources and services by direct exchange between computing devices and systems. These resources and services include the exchange of information, cache storage, and disk storage for files. Distributed computing takes advantage of network connectivity, allowing clients to leverage their collective power to benefit the entire enterprise. In this regard, a variety of devices may have applications, objects or resources that may utilize the techniques of the present invention.

With reference to FIG. 2, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium that can be used to store the desired information and that can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Use of High-Cardinality Attributes in a Decision Tree

Zipf's Law is a mathematical law regarding certain real-world data. Zipf's Law holds that, unlike truly random data, the distribution of certain real world data follows a certain predictable pattern. To reveal this pattern, data containing an attribute with a number of possible states is examined. The support for each state is determined. Support is proportional to the number of cases from the data matching that state. The states are then sorted by support, from highest support (state with the most cases having that state for the attribute) to lowest (state with the least cases having that state for the attribute). When a graph is created showing states from highest support to lowest along the X-axis, and the support graphed on the Y-axis, a curve is revealed. When charted on a graph with the X and Y axes both displayed on a logarithmic scale, the graph will be of a straight line with a curve of −1.

Zipf's Law shows that for certain real world data, support for states is not distributed randomly. A very few states have a majority of the support. Zipf's Law has been shown to be useful on data including: population data divided into states or zip codes; language data describing the number of instances of specific words or phrases; and web page use data.

Zipf's curve indicates that certain states will be more prevalent in data. Additionally, generally, more popular states of a high-cardinality attribute affect other attributes more than less popular ones. This is used in order to allow the use of high-cardinality data in decision trees.

Use of a High-Cardinality Attribute as Input Attribute in a Decision Tree

When a high-cardinality attribute is used as an input attribute in a decision tree, correlation tables comparing the attribute to output attributes need to be created. According to one embodiment of the invention, these tables are created only for certain states of the high-cardinality input attribute.

The inventive technique may be used iteratively, at each node where the high-cardinality attribute is being considered as an input attribute. The testing data at the node of the decision tree for which an attribute test is being selected is used to create scoring information. This scoring information is used to determine the attribute test to be used at the node.

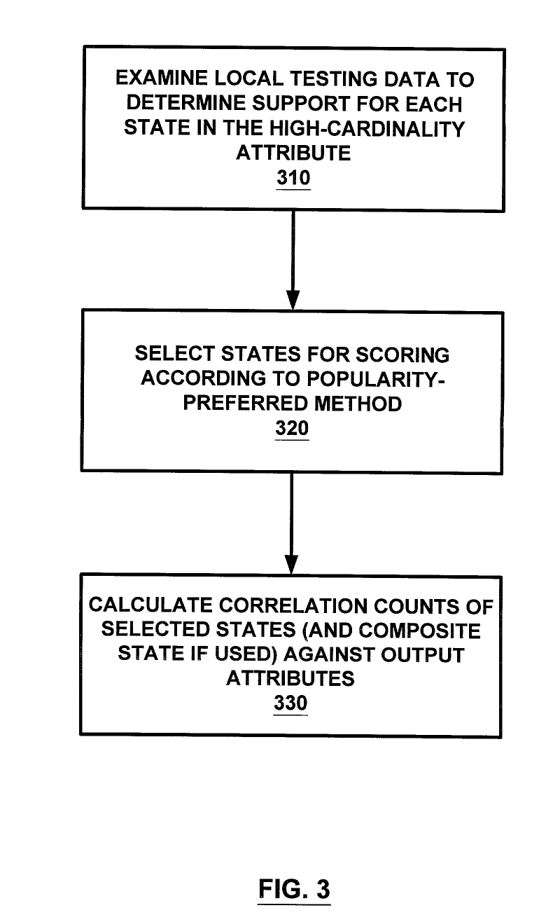

In order to allow the use a high-cardinality attribute as an input attribute, as shown in step 310 in FIG. 3, the testing data is first examined to see what the support is for each state in the high-cardinality attribute. According to the inventive technique, only some of the testing data is examined to determine the support for each state. This marginal support is used. In an alternative embodiment, all the testing data is examined to determine the support for each state. I

When support is determined for each state in the high-cardinality attribute at the node, certain states of the high-cardinality attribute are selected for scoring, as shown in step 320. These states are selected according to a popularity-preferred method.

In one embodiment, the popularity-preferred method selects a number N of the most popular states for possible use in an attribute test for the node. In one embodiment, a composite state is also considered for use in an attribute test for the node. The composite N+1st state amalgamates all the states not included in the N most popular states. This composite state is also considered for use in an attribute test for the node. When this composite state is used, all the testing data at the node is in one of the N+1 states.

In one embodiment, the threshold N may be tunable based on the processing capability or memory space available. In one embodiment, the threshold N may be based on the number of states of the high-cardinality attribute. In one embodiment, the threshold N may be based on the distribution of support—if few states contain significant support, the threshold N may be reduced. If the distribution is even across many states, the threshold N may be increased. In one embodiment, there is an absolute maximum value for N.

In step 330, once the states to be used have been determined, the correlation counts for these states are calculated against the output attributes. Correlation counts for all other input attributes (which may include other high-cardinality attributes handled according to the method of the invention) are also calculated. The attribute test to be used to create the split at that node is determined according to scoring based on the correlation counts.

In one embodiment, this process may be repeated iteratively at a number of nodes, with support calculated, a certain number of states of the attribute selected, and correlation count tables created at each node. The process shown in FIG. 3 would be repeated for each node.

For example, suppose the high-cardinality attribute being considered is USState, which stores a U.S. state for each element of the data set. Using the data at the node under consideration, support may be calculated for the different possible values of USState. If the values (or states) for USState, in order of support, are <TX, WA, CA, AZ, MI, AL, . . . >, and N is 4, then the correlation count tables will be produced for TX, WA, CA, and AZ. In the embodiment where a composite state is used, a correlation count table will be produced for this composite state as well.

If WA turns out to be the best candidate for input attribute test when the correlation count table for TX, WA, CA, AZ, and any other possible input attribute tests based on other attributes are considered, the input attribute test may be ‘USState=WA’ and ‘USState≠WA’. The data at the node will be split into the two children of the node based on this test. Now, consider the data at the child node where ‘USState≠WA.’ If the USState attribute is being considered for an attribute test at this child node, the technique is performed again. The support for USState at that node must be considered. Either using the previously calculated support or newly calculating support, the values for USState in order of support will likely be <TX, CA, AZ, MI, AL, . . . >. (If support is calculated again, and calculated only based on some portion of all data at the node, it is possible that a different order will result.) Now if N=4, the states which will be considered are TX, CA, AZ, and MI. The most popular states are always considered at the node, but as the tree evolves, states will have been used as attribute tests at higher nodes, and will no longer be considered at the lower nodes.

Use of a High-Cardinality Attribute as Output Attribute in a Decision Tree

When a high-cardinality attribute is used as an output attribute in a decision tree, correlation tables comparing input attributes to the high-cardinality attribute need to be created. According to one embodiment of the invention, these tables are created only for certain states of the high-cardinality output attribute.

The inventive technique may be used iteratively, at each node where the high-cardinality attribute is being considered as an output attribute for the node. The testing data at the node of the decision tree for which an output attribute is being selected is used to create scoring information for the node. This scoring information is used to determine the attribute test to be used at the node.

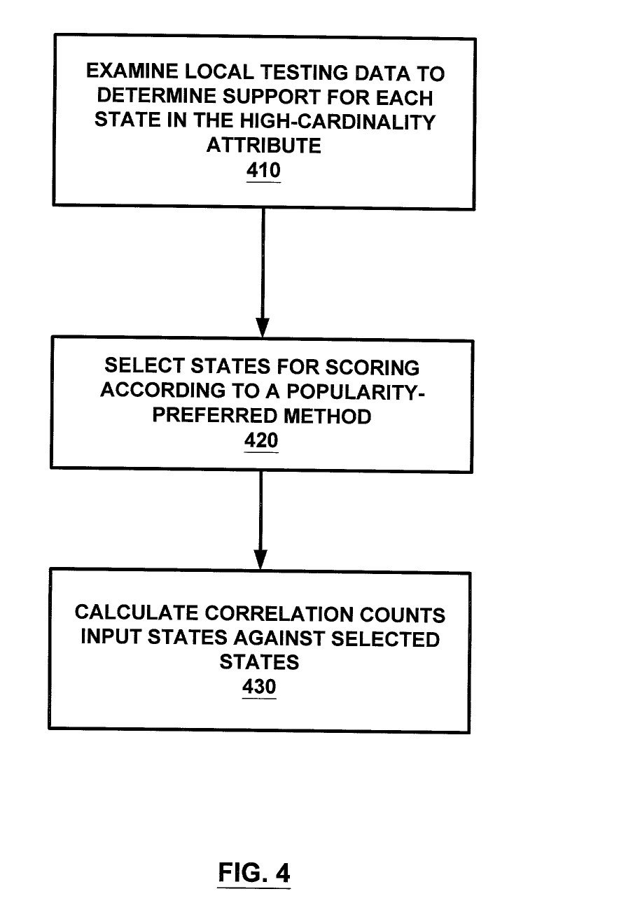

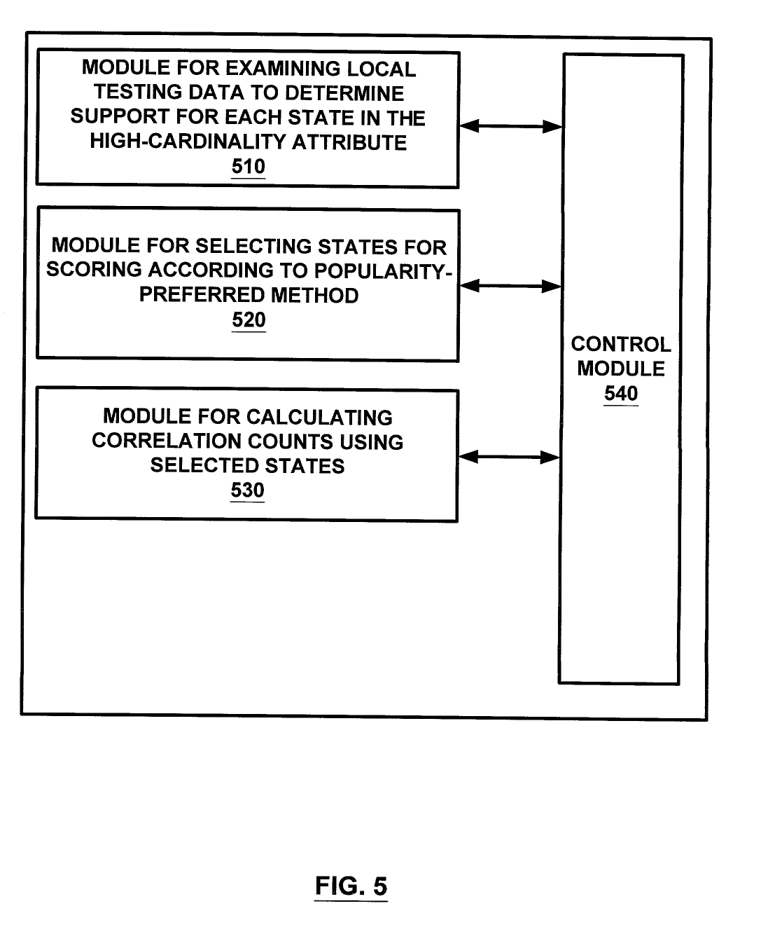

In order to allow the use a high-cardinality attribute as an output attribute, as shown in step 410 in FIG. 4, the testing data is first examined to see what the support is for each state in the high-cardinality attribute. Again, only some of the testing data is examined to determine the support for each state. This marginal support is used. In an alternative embodiment, all the testing data is examined to determine the support for each state.

When support is determined for each state in the high-cardinality attribute, certain states of the high-cardinality attribute are selected for scoring, as shown in step 420. These states are selected according to a popularity-preferred method.

In one embodiment, the threshold N may be tunable based on the processing capability or memory space available. In one embodiment, the threshold N may be based on the number of states of the high-cardinality attribute. In one embodiment, the threshold N may be based on the distribution of support—if few states contain significant support, the threshold N may be reduced. If the distribution is even across many states, the threshold N may be increased. In one embodiment, there is an absolute maximum value for N.

In step 430, once the states to be used have been determined, the correlation counts for input attributes versus these states of the high-cardinality output attribute are calculated. Correlation counts for input attributes versus other output attributes (which may include other high-cardinality attributes handled according to the method of the invention) are also calculated. The attribute test to be used to create the split at that node is determined according to the correlation counts.

In one embodiment, this process may be repeated iteratively at a number of nodes, with support calculated, a certain number of states of the attribute selected, and correlation count tables created at each node. The process shown in FIG. 4 would be repeated for each node.

As shown in FIG. 5, a system according to this invention includes a module for examining local testing data to determine support for each state in the high-cardinality attribute 510, a module for selecting states for scoring according to a popularity-preferred method 520, and a module for calculating correlation counts using selected states 530. In a preferred embodiment, a control module 540 is also provided which communicates with each of these modules.

Conclusion

Herein a system and method for using high-cardinality attributes as input attributes in decision tree creation. Certain states of the attributes are selected according to a popularity-preferred method. A composite state representing all of the remaining states is also created. The popularity-preferred states and the composite state are considered as possible input attributes for attribute tests for the node. The technique may be performed iteratively at subsequent nodes.

The invention also contemplates using high-cardinality attributes as output attributes in decision tree creation. Certain states of the attributes are selected according to a popularity-preferred method. The popularity-preferred states and the composite state are considered as possible output attributes when selecting an attribute test for the node. The technique may be performed iteratively at subsequent nodes.

As mentioned above, while exemplary embodiments of the present invention have been described in connection with various computing devices and network architectures, the underlying concepts may be applied to any computing device or system in which it is desirable to create a decision tree. Thus, the techniques for creating a decision tree in accordance with the present invention may be applied to a variety of applications and devices. For instance, the algorithm(s) of the invention may be applied to the operating system of a computing device, provided as a separate object on the device, as part of another object, as a downloadable object from a server, as a “middle man” between a device or object and the network, as a distributed object, etc. While exemplary programming languages, names and examples are chosen herein as representative of various choices, these languages, names and examples are not intended to be limiting. One of ordinary skill in the art will appreciate that there are numerous ways of providing object code that achieves the same, similar or equivalent parametrization achieved by the invention.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the techniques of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, or a receiving machine having the signal processing capabilities as described in exemplary embodiments above becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for using a high-cardinality attribute as an input attribute or as an output attribute for a decision tree, comprising:
determining support for each state in said high-cardinality attribute; and
selecting states of said high-cardinality attribute for use based on said support.

2. The method of claim 1, where said determination of support and said selection of states occurs whenever a node with an associated data set is considered for a possible split and said high-cardinality attribute is being considered as an input attribute or an output attribute, and where said support is determined relative to said associated data set at said node.

3. The method of claim 1, where said determination of support for each state in said high-cardinality attribute comprises determining the support for each state in a percentage of cases from data set being considered.

4. A method according to claim 3, where said percentage is 100%.

5. A method according to claim 3, where said percentage of cases are randomly selected from said testing data set.

6. A method according to claim 1, where said selection of states of said high-cardinality attribute for use based on said support comprises:
selecting the N states with the highest support.

7. A method according to claim 6, where said high-cardinality attribute is being considered for use as an input attribute and where said selection of states of said high-cardinality attribute for use based on said support further compromises:
including a N+1st state comprising all of the states of said high-cardinality attribute not included in said N states with the highest support as a state for use.

8. A method according to claim 6, where said number N is dynamically chosen based on information comprising the distribution of said support among the states of said high-cardinality attribute.

9. A method according to claim 6, where said number N is chosen by a user.

10. A method according to claim 1, further comprising:
using said states of said high-cardinality attribute in a split score determination to determine an input attribute and an output attribute for use in the decision tree.

11. A method according to claim 1, where said determination of support and said selection of states is performed iteratively at each of two or more nodes where said high-cardinality attribute is being considered for use.

12. A computer-readable medium comprising computer-executable modules having computer-executable instructions for using a high-cardinality attribute as an input attribute or as an output attribute for a decision tree, said modules comprising:
a module for determining support for each state in said high-cardinality attribute; and
a module for selecting states of said high-cardinality attribute for use based on said support.

13. The computer-readable medium of claim 12, where said determination of support and said selection of states occurs whenever a node with an associated data set is considered for a possible split and said high-cardinality attribute is being considered as an input attribute or an output attribute, and where said support is determined relative to said associated data set at said node.

14. The computer-readable medium of claim 12, where said module for determining support for each state in said high-cardinality attribute comprises: a module for determining the support for each state in a percentage of cases from data set being considered.

15. The computer-readable medium of claim 14, where said percentage is 100%.

16. The computer-readable medium of claim 14, where said percentage of cases are randomly selected from said testing data set.

17. The computer-readable medium of claim 12, where said module for selecting states of said high-cardinality attribute for use based on said support comprises:
a module for selecting the N states with the highest support.

18. The computer-readable medium of claim 17, where said high-cardinality attribute is being considered for use as an input attribute and where said module for selecting states of said high-cardinality attribute for use based on said support further compromises:
a module for including a N+lst state comprising all of the states of said high-cardinality attribute not included in said N states with the highest support as a state for use.

19. The computer-readable medium of claim 17, where said number N is dynamically chosen based on information comprising the distribution of said support among the states of said high-cardinality attribute.

20. The computer-readable medium of claim 17, where said number N is chosen by a user.

21. The computer-readable medium of claim 12, further comprising:
a module for using said states of said high-cardinality attribute in a split score determination to determine an input attribute and an output attribute for use in the decision tree.

22. The computer readable medium of claim 12, where said determination of support and said selection of states is performed iteratively at each of two or more nodes where said high-cardinality attribute is being considered for use.

23. A computer device for using a high-cardinality attribute as an input attribute or as an output attribute for a decision tree, comprising:
means for determining support for each state in said high-cardinality attribute; and
means for selecting states of said high-cardinality attribute for use based on said support.

24. The computer device of claim 23, where said determination of support and said selection of states occurs whenever a node with an associated data set is considered for a possible split and said high-cardinality attribute is being considered as an input attribute or an output attribute, and where said support is determined relative to said associated data set at said node.

25. The computer device of claim 23, where said means for determining support for each state in said high-cardinality attribute comprises means for determining the support for each state in a percentage of cases from data set being considered.

26. The computer device of claim 25, where said percentage is 100%.

27. The computer device of claim 25, where said percentage of cases are randomly selected from said testing data set.

28. The computer device of claim 23, where said means for selecting states of said high-cardinality attribute for use based on said support comprises:
means for selecting the N states with the highest support.

29. The computer device of claim 28, where said high-cardinality attribute is being considered for use as an input attribute and where said means for selecting states of said high-cardinality attribute for use based on said support further compromises:
means for including a N+1 st state comprising all of the states of said high-cardinality attribute not included in said N states with the highest support as a state for use.

30. The computer device of claim 28, where said number N is dynamically chosen based on information comprising the distribution of said support among the states of said high-cardinality attribute.

31. The computer device of claim 28, where said number N is chosen by a user.

32. The computer device of claim 23, further comprising:
means for using said states of said high-cardinality attribute in a split score determination to determine an input attribute and an output attribute for use in the decision tree.

33. The computer device of claim 23, where said determination of support and said selection of states is performed iteratively at each of two or more nodes where said high-cardinality attribute is being considered for use.
